(19) United States
(12) Patent Application Publication
(10) Pub. No.: US 2015/0164281 A1
(43) Pub. Date: Jun. 18, 2015

(54) KITCHEN APPLIANCE WITH AN ELECTRICALLY DRIVEN MOTOR AND METHOD FOR AUTOMATICALLY PREPARING A DISH

(71) Applicant: Vorwerk & Co. Interholding GmbH, Wuppertal (DE)

(72) Inventors: Hendrik Koetz, Witten (DE); Volker Greive, Wuppertal (DE); Torsten Lang, Solingen (DE); Markus Cornelissen, Leichlingen (DE); Maria Jose Resende, Wollerau (CH); Stefan Hilgers, Essen (DE)

(73) Assignee: Vorwerk & Co. Interholding GmbH, Wuppertal (DE)

(21) Appl. No.: 14/415,834

(22) PCT Filed: Jul. 10, 2013
(86) PCT No.: PCT/EP2013/064549

§ 371 Date: Jan. 20, 2015

(30) Foreign Application Priority Data
Jul. 23, 2012 (DE) 10 2012 106 642.6
Jun. 26, 2013 (DE) 10 2013 106 691.7

(51) Int. Cl. A47J 43/07

(52) U.S. Cl. CPC A47J 43/0716

(57) ABSTRACT

To begin with, the invention relates to an electrically driven kitchen appliance comprising a heatable stirring vessel, which is embodied to accommodate a stirring mechanism, wherein the kitchen appliance is embodied for automatically preparing a dish according to a predetermined execution program. In addition, the invention relates to a method for automatically preparing a dish in an electrically operated kitchen appliance comprising a heatable stirring vessel, which is embodied to accommodate a stirring mechanism. To specify an electrically operated kitchen appliance and a method for automatically preparing a dish, which make it possible for the preparation to turn out as well as possible with regard to the characteristics or quality, respectively, of the prepared dish, it is proposed that that an appliance and/or an environmental state can be measured with regard to state parameters, such as stirring vessel temperature and/or humidity, or can be input as value, that a measurement value obtained hereby or input value can be compared to an initial value, which is considered in the execution program, and that deviations from the initial value can be considered by automatically adapting preparation parameters, such as heating time and/or heating temperature, which are included in the execution program. In response to a subsequent step, a change can also be made as a function of a change in response to a preceding step.

The invention relates first to a kitchen appliance with an electrically driven motor comprising a heatable stirring vessel, which is formed to accommodate a stirring mechanism, wherein the kitchen appliance is made for automatically preparing a dish according to a predetermined execution program.

The invention furthermore relates to a method for automatically preparing a dish in a kitchen appliance with an electrically driven motor comprising a heatable stirring vessel, which is embodied for accommodating a stirring mechanism.

Such kitchen appliances are already known in many respects. For example, reference is made to DE 102007059236 A1, furthermore for example to EP 757530 B1, relating to a special preparation of a dish, as can also be used in the case at hand, reference is furthermore is made to EP 1274333 B1, which in particular describes a heating device for a stirring vessel for such a kitchen appliance.

Such kitchen appliances have also already become known to the effect that they provide for an automatic, programmable preparation of a dish, in particular an automatic execution of a recipe. As is also preferred in the context of the application, the execution can take place by successively executing recipe steps, of which the recipe consists. As is preferred as well, one, a plurality or all recipe steps can hereby furthermore require the express release or a start signal from a user for executing. In the context of such execution, a preparation parameter, such as in particular a temperature, which is reached in the stirring vessel, for example a stirring vessel bottom, and/or a stirring mechanism speed, with which a stirring mechanism, which is located in the stirring vessel, is driven, can be controlled or regulated automatically in a program-controlled manner.

In this regard, reference is to also be made in particular to WO 2011/069833 A1. Said features can also be relevant as features of the invention described herein.

In response to automatically carrying out a preparation of a certain dish, which is suitable for human consumption, for example the execution of a recipe referring to this or a recipe step, it turns out from time to time that the desired, in particular (repeatedly) the same results, as were achieved in the laboratory, for example in response to the creation of a recipe, are nonetheless not achieved in spite of providing preparation parameters, such as a quantity of food to be prepared, which must be input, and/or a heating temperature of the stirring vessel and/or with regard to a speed, which is to be set at a stirring or grinding mechanism.

Based on this, the invention deals with the task of specifying a kitchen appliance with an electrically driven motor and a method for automatically preparing a dish, which make it possible for the preparation to turn out as well as possible with regard to the characteristics or quality, respectively, of the prepared dish.

A possible solution of the task with regard to the kitchen appliance is at hand according to a first inventive idea in the case of a kitchen appliance, which is equipped such that an appliance and/or environmental state can be measured with regard to state parameters, such as stirring vessel temperature and/or humidity, or such that a corresponding value for the execution according to a program can be input, such that a measurement value obtained hereby or an input value can be compared to an initial value, which is considered in the execution program and such that a deviation from the initial value can be considered by means of an automatic or proposed adaptation of preparation parameters included in the execution program, such as heating time and/or heating temperature. The stirring vessel temperature can in particular refer to an initial stirring vessel temperature. It can be considered with this, whether the stirring vessel encompasses a stirring vessel temperature, which deviates from the stirring vessel temperature, which is typically implied in a recipe, for example because it had been placed into a dishwasher or a refrigerator shortly before.

The kitchen appliance encompasses an embodiment, which provides for an adaptation of one or a plurality of predetermined preparation parameters, such as, for example, the speed, the duration of a stirring mechanism operation, the heating temperature of the stirring vessel and/or a heating gradient of the stirring vessel in consideration of measurement values or input values of the kitchen appliance and/or of the environment, in which the kitchen appliance is operated. Provision can be made hereby for this adaptation to take place automatically, without the user having to interfere and, if applicable, also without a corresponding notification to the user. However, provision can also be made for this input and execution of the values to lead to a corresponding display and/or that it is up to the user to decide, whether a consideration is to take place in response to the further execution as described above. The execution program, for example a recipe or an individual recipe step referring to this, hereby includes a dependence, which is provided in the form of a formula, for example, of such a preparation parameter from the state parameter in a suitable manner. A context in table form can also be stored, for instance when a formula-related context is not known or not possible. The values of the table can be determined empirically, for example.

In particular in the case of dishes, which include or relate to food to be prepared, such as eggs and/or flour and/or milk, differences as compared to the values, which are stored in an execution program and which are perceived comparatively slightly, such as a temperature of the stirring vessel, into which the food to be prepared is placed, or a prevailing air pressure or a prevailing humidity can have a significant influence on the success of the preparation. In further detail, the humidity can be a humidity, which is measured inside the stirring vessel or outside the stirring vessel, but at the kitchen appliance itself or in the vicinity, preferably in the direct vicinity thereto. The vicinity can refer to a domestic location, in which the kitchen appliance is used, but it can also refer to a city or a region, in which the kitchen appliance is used. In particular, this can obviously be measurement values of the kitchen appliance itself or of a resident, for example comprising a separate moisture meter, but can also be values, which are queried or transmitted via institutions, such as meteorological observatories. However, with regard to the humidity, for example, but also for instance with regard to an air pressure, they can also be values, which are transmitted to the kitchen appliance via radio or in another manner or which are input as values by a user in response to a corresponding query.

The corresponding values of the temperature, etc., which are stored in the execution program for the determination of preparation parameters provided therein, can be fixedly preset. However, they can also be provided so as to be capable of being influenced by the user, for example. For this purpose, a request can also be made to the user, for instance with regard to the current humidity or the current air temperature.

Provision can furthermore be made in the recipe, which is to be processed, for quantities, which can be influenced by the user, for instance when the recipe is designed for two persons, but if a quantity is to actually be prepared for four persons, provision can be made for the user to change the set-point value directly or inputs a different number with regard to the designated number of persons, which is then converted in a program-controlled manner with regard to new initial values, which now form the basis. For this, provision can also be made in terms of programming for a table, because such conversions cannot always be determined in the form of a formula.

However, provision can furthermore also be made for such a table to be capable of being influenced by the user, for instance if the user wants to consider his own empirical values. As already noted, said quantities are also preferably provided so as to be capable of being changed in the execution program more preferably so as to be automatically changeable, namely in particular automatically changeable with regard to other state parameters, which form the basis for the creation of the execution program.

The execution program, if applicable also relating (only) to one recipe step, can be, if applicable among others, that an impact, which is made by means of a predetermined first speed, on a food to be prepared, wherein this first speed can be maintained automatically by the kitchen appliance by measuring and, if applicable, by correcting the actual speed. The electronic motor management of the kitchen appliance can thus have an automatic regulation or control of the predetermined first speed be performed or reached, respectively. In this context, the execution program can furthermore include that said predetermined first speed is to be changed to a predetermined second speed, preferably lowered, wherein the second speed is not automatically maintained by the kitchen appliance. This means that the actual second speed can be higher or lower than the predetermined second speed. However, the actual second speed can nonetheless be capable of being determined in a sufficient manner by means of a sensor, for instance by means of a revolution counter, such as a light barrier or by means of a Hall sensor. With regard to the actual second speed, the kitchen appliance itself can accordingly also carry out a comparison, whether it corresponds to the predetermined speed or to what extent it deviates therefrom. This extent of the deviation, which can preferably be provided as absolute value, thus a difference of approximately five revolutions per minute to the predetermined speed with regard to the speed, can now be used for the evaluation, namely as measure for the viscosity of the food to be prepared.

In the context of said execution program, it is preferred, in particular that a repeated change takes place between the predetermined first and predetermined second speed. If applicable, a change between more than 2, for example 3 or more predetermined speeds can also be made. If a change is made between a plurality of predetermined speeds, provision is made at least with reference to a second predetermined speed, which deviates from the first predetermined speed, for said automatic maintaining of this actual second speed not to be made by the kitchen appliance. A deviation from the predetermined second speed, which might then be reached, can be evaluated as described above and can be used to draw a conclusion to the state of the food to be prepared. Due to the repeated change, a gradient of the deviation can also be determined in consideration of the time axis. The gradient can be used, for example, with regard to a forecasting.

In addition, it is preferred for said execution program to include a plurality of changes, preferably a plurality of changes between an at least first and an at least second predetermined speed, which, on principle, is provided for a time period, which is so long that the time period provided for this execution program or for this part of the execution program (change between two or more predetermined speeds), respectively, cannot be exhausted so as to reach the final state of the food to be prepared, which is desired by the respective preparation.

Preferably, such an execution program is preferred in particular for preparing cream. Starting at an initial liquid state, thus virtually the state as offered by normal milk, this food to be prepared can be influenced, starting with a constant, quasi zeroed predetermined speed, for a first predetermined time period, for example. After a predetermined time period has lapsed, after which a first significant change (rise) of the viscosity can typically be expected at the earliest, a change between a predetermined first high speed and a predetermined second low speed can occur according to the program. The predetermined high speed can be in the range of between 200 and 600 U/min, for example, more preferably between 300 and 500 or approximately 400 U/min, while the second, low speed can be in the range of between 10 and 70 U/min, more preferably between 20 and 60 U/min and furthermore preferably be 40 U/min.

With regard to empirically stipulated target values, which can be at hand such that, when reaching a second actual speed of 35 U/min, the desired viscosity of the cream is at hand, for example in response to setting the second speed to 40 U/min, one can proceed according to the above-mentioned process. If the target value of the second speed is not (yet) reached, one can switch back to said initial speed (zeroed speed) after a predetermined further (second) time period has lapsed, during which the kitchen appliance is operated at this lower speed. However, the predetermined time period for this initial speed can be different, it can in particular be smaller than in response to the first operation with this initial speed.

When reaching an actual second speed of or below the predetermined maximally permissible speed of 35 U/min, for example, a conclusion can thus be drawn that the desired viscosity has been reached and the execution program can stop automatically at that point in time. This stop means that the stirring mechanism is turned off, thus that an active stirring is not carried out any longer.

In the event that the food to be prepared is not cream (as targeted), such as a certain sauce, for example, in the case of which it might be desired that it is nonetheless still kept at a certain temperature, after a predetermined viscosity has been reached due to stirring mechanism application or the temperature is decreased only slowly, the ending of the execution program can also be limited only to the stirring mechanism activity (speed) in this regard, but the heating activity can still be continued accordingly.

Ending the stirring mechanism activity can also signify that even though the stirring mechanism is still operated, if applicable also within larger time intervals, it is only operated to such an extent that virtually no impact is to be expected any longer on a viscosity change of the food to be prepared any longer or occurs, respectively, because a burning, for example, is to be prevented.

More preferably, an execution program can also refer to a preparation of jam, whereby the above-mentioned example of a sauce can also be used herein. In this context, but also independent therefrom, a state parameter can also be provided in a weight of the food to be prepared. Due to the fact that it can also be desired in the mentioned case or the examples and in the case of other food to be prepared that it loses a part of its mass, for example due to evaporation, for instance when a desired thickening can be reached through this, the weight provides an indication for how far this desired process has progressed.

In this regard, the execution program can provide for food to be prepared, which is placed into the stirring vessel, to be capable of being checked or to be checked, respectively, continuously or within certain time intervals, respectively, with regard to its state parameter weight and that an automatic ending of the execution program can be carried out as a function of reaching a predetermined value of this state parameter, the weight. As already explained above, said automatic ending, in turn, can possibly refer to the one state parameter, which can substantially be significant for said weight change in such a context, thus in particular a heating temperature as preparation parameter. The ending can also suggest here that no heat or only an insignificant amount of heat is introduced into the food to be prepared, but that the stirring mechanism, for example, is still actively operated.

In the previous cases, the measuring of the preparation parameter, thus in this example the measuring of viscosity, as it has also been explained using the example of the preparation of cream, can also be carried out in combination with the determination of a further preparation parameter, so as to obtain greater security with regard to the ending of the execution program. In the case considered above, this thus means that not only the preparation parameter weight, but also the preparation parameter viscosity is measured and is considered according to the program.

A further embodiment of the execution program with regard to automatically reaching a state of the food to be prepared, which is as optimal as possible, can be that a temperature measurement with regard to the food to be prepared, if applicable the temperature of a hot plate, can be carried out or is carried out, respectively, either continuously or within certain time intervals in the course of this execution program, and that an ending of the execution program can be carried out or is carried out, respectively, automatically, when a predetermined temporal increase of the temperature is reached or exceeded, respectively. Obviously, it is thereby not (seemingly) important that a certain absolute temperature is reached, but that a certain temperature gradient is reached.

On the other hand, the respective absolute reached temperature can also be included in the evaluation as state parameter.

Such a temperature measurement can be important, for example in response to a preparation of rice. For a preparation of rice, a required quantity of water, if applicable mixed with a certain portion of salt and/or oil, is preferably initially placed into a stirring vessel and a heating takes place, preferably in response to a simultaneous stirring. Initially, this liquid is heated to the boiling point and the actual food to be prepared, rice in this case, is then added. The actual food to be prepared can also be included at the same time.

A cooking then takes place at the boiling point, which, due to the boiling point temperature, which is reached naturally, has the result that virtually a constant temperature prevails in response to sufficient heat output. In the course of this preparation, however, the water evaporates, so that the portion of water, which is present in the stirring vessel at a certain point in, time, is only so small that a temperature increase, in response to the (same) heat output, which is still at hand, takes place beyond said boiling point temperature. If a corresponding measuring of the temperature as state parameter is now carried out, preferably at regular intervals, this temperature increase (gradient) can be identified. At the same time, it is an indication for the fact that the preparation of the rice has ended and can thus be considered as a signal, in this case for ending the execution program.

According to the method, the food to be prepared is checked with regard to the state parameters, in particular in the above-described general case, preferably, at least initially, after being placed into the stirring vessel, namely more preferably immediately after being put in, so that the state parameters are checked, for example within one or within up to five minutes after putting in the food to be prepared, or are requested by the device to be put in. They can then be considered in the execution program with regard to preparation parameters, such as speed, length of time, heating temperature, etc. These state parameters can in particular also be environmental parameters. The above-mentioned parameters humidity and/or air pressure can in particular be considered as environmental parameters. These state parameters, which are specific as environmental parameters, are preferably determined simultaneously with other state parameters, if possible. For example, moisture content of the food to be prepared and/or (initial) temperature of the food to be prepared (for example for differentiating, whether it comes from the refrigerator or has a (high) ambient temperature) and/or, for instance in response to a mass, which is pourable on principle, viscosity of the food to be prepared, are also possible as other state parameters. The kitchen appliance can hereby display a change to an initial value, which might have been made in an execution program, preferably with the possibility for the user to accept the change for continuing to carry out the execution program, to dismiss it and/or to change it personally.

In addition or in the alternative, a preparation parameter and/or a state parameter can be carried out (for the first time) with regard to the food to be prepared in the context of an execution, as in particular explained by means of the above-specified example, thus for example during a stirring and/or heating phase or can be carried out repeatedly. It can also be carried out several times during this execution.

In addition or as an alternative to the described possibilities for detecting such values, which are inherent to the kitchen appliance, provision can be made for this purpose in or at the kitchen appliance for suitable sensors or the values can be determined on the user side by means of a separate measuring instrument and can then be input, if applicable in response to a corresponding query from the device during the program sequence.

Further features of the invention will be described or illustrated below, respectively, often in their preferred assignment to the concept, which has already been explained above. However, they can also be important in an assignment to only one or a plurality of individual features, which are described herein, or independently, or in a different overall concept. Features of the kitchen appliance, which are described in the course of the description of the method, can in particular also be important for the subject matter of the kitchen appliance, and, vice versa, methods, which are explained in the context of the description of the kitchen appliance, can also be important for the method features of the invention.

The set-up of the kitchen appliance such that it can determine mentioned or at least one of the state parameters and/or environmental parameters and can also influence the execution program, is also attained in particular in that the kitchen appliance encompasses a microprocessor, which can carry out a corresponding execution of detected signals. This microprocessor preferably also controls the execution program as such. Preferably, a data storage, in particular a non-volatile, but preferably a changeable data storage, in which an operating program and/or a value table, etc. can be stored, is assigned to the microprocessor, more preferably in the kitchen appliance itself. Provision can furthermore be made for one or a plurality of sensors, which are arranged directly in the kitchen appliance and which supply the desired values. The determination of the values can also be attained by procedural methods of the kitchen appliance, such as also explained above and below, and parameters determined thereby, such as current and/or voltage, etc. In addition or in the alternative, such a value can also be included on a label of the food to be prepared, if it is still packaged, and can be scanned by the kitchen appliance, for example via a reader. As a further alternative or in addition, values can also be input freely, for instance with regard to a query by the kitchen appliance. These can be values, such as moisture content of the food to be prepared, degree of ripeness of the food to be prepared, temperature of the food to be prepared, etc.

In addition, in particular environmental values can also be obtained as state parameters by automatic transfer, for instance via WLAN, Bluetooth and/or other radio signals from devices located outside of the kitchen appliance. The kitchen appliance can furthermore request such environmental parameters, such as air temperature or air moisture, for example, for manual inputting by a user. In the event that a value is not input, provision can also be made for a standard value to be used or for the value, which already forms the basis, to be maintained.

It is furthermore also preferred that the adaptation of an initial value can be made in consideration of a threshold value, which is inherent to the food to be prepared. This means, for example, that a grinding process cannot be triggered in response to a grinding of flour when a certain temperature limit has been exceeded and/or when a warning is given to the user for not carrying out the grinding process or for not granting a release for the grinding process, and/or that a grinding process is stopped automatically and/or a warning signal is output by the kitchen appliance for stopping the preparation process, here the grinding process, because in the case of flour, nutrients contained in the flour can be damaged as a function of the temperature. This can occur, for example, when the food to be prepared, namely flour, is placed into a stirring vessel, which was previously used while heating a different food to be prepared and the temperature does not yet prevail in the stirring vessel when putting in the flour.

As has already been explained above with regard to more specific cases, it is preferred, in particular that a state parameter can be determined by means of an appliance part, which has a preparatory effect on the food to be prepared in response to the preparation thereof. The determination of state data by means of sensors is thus not limited to the fact that the determination takes place for a predetermined time period prior to a preparation step, such as, for example, a stirring at a certain speed and, if applicable, at a certain temperature. Instead, a determination of a state parameter can also be made during the execution of a preparation step, thus for instance an operation of the stirring mechanism in response to a predetermined speed for a predetermined time period.

In response to a preparation of flour by stirring in milk and/or eggs, for example, a certain stirring resistance, which can also change over time, can be expected with regard to the predetermined quantity of the food to be prepared. This stirring resistance, which can be used as measure for the viscosity of the food to be prepared, can be determined and predetermined as initial value in an execution program, if applicable in the form of a table, and with a certain margin. If this stirring resistance, which can be measured via the motor current of the electric motor, which drives the stirring mechanism, for example, differs from or in addition to the above-described examples relating to cream or jam, from the initial value, which can accordingly also include an initial value range and which can in particular be predetermined so as to be variable via the time axis, is not included in this default value any longer, this can be used to notify the user of this deviation from the requirement or from the expected value, respectively, but, if applicable, to simultaneously also adapt the speed and/or the length of time of the stirring process accordingly and/or to propose to the user to refill a further food to be prepared, such as, for instance, a certain quantity of milk and/or eggs, for instance for a further thinning, if the resistance becomes too high.

In the case of the example of the preparation of cream, but also independent therefrom, provision can be made, for example, for the stirring mechanism to be operated in a programmed sequence at a lower speed, for example 30 to 50 U/min, preferably 40 U/min, and at a high speed, for example 300 to 500 U/min, preferably 400 U/min. A single-oscillating or multi-oscillating operation then results between such speeds. With an increasing change of the viscosity of the medium, which is to be processed, in the case herein thus with an increasing stiffness of the cream, for example, it can happen that the lower default value speed can no longer be maintained by the electromotor or, that provision is no longer made for maintaining the speed, for instance when a certain minimum speed is fallen below. This lower speed is then undercut. It is possible to determine this undercut by means of a revolution counter, the motor current or for example also via a light barrier. It can be determined as a function of the undercutting of the speed or of a series of undercutting of the speed via a predetermined range of the oscillating operation that the preparation step is to be ended, thus for example that the cream can be considered as having been prepared to completion. The appliance can then turn off and can report a completion, but, if a further preparation step, for instance stirring further food to be prepared into the cream, which was completed in this manner, is to take place, the appliance can then also quasi announce this step for being carried out.

Said determination, whether a food to be prepared has been prepared to completion, for example also whether a recipe step can be considered as being completed in this card, can also be attained, for instance in that the stirring mechanism rotates at a high speed, for instance within the above-specified upper range, and that the drive is turned off at this speed. A measuring can then be carried out, until the drive reaches a lower, predetermined speed in response to levelling off or until it comes to a standstill, for example. If this takes place within a predetermined threshold value, in particular a temporal threshold value herein, this determination of a characteristic value can also be considered as an ending of the corresponding recipe step or of the corresponding preparation and can be evaluated in the manner already described above by the kitchen appliance.

In the alternative or in addition, the temporal value can also be used, which the stirring mechanism requires for starting up, in particular from a standstill or from a predetermined low speed, and can then trigger the corresponding sequence in the kitchen appliance, as described, in the same manner.

As a further alternative or in addition, an inversion of the direction of the stirring mechanism, in particular the time required by the stirring mechanism for changing from a predetermined speed in one direction into a predetermined speed, preferably the same speed, in the other direction, can also be used.

A sequence of movements, which serves to determine the state parameter, can be capable of being carried out accordingly in this manner by means of an appliance part.

For example, an appliance part can furthermore also influence the food to be prepared in that - as in the case of a flow baffler, which projects inwards from the stirring vessel wall—it is subjected to a certain pressure in response to the stirring which can also be different as a function of the viscosity of the food to be stirred, and can also assume different values in particular via the time axis. This pressure can be determined via suitable sensors, which in particular determine the strain on the stirring vessel wall, such as, for instance, expansion measuring strips attached to the stirring vessel wall, and are used in the same manner for determining the actual state of the food to be prepared or of a mass to be prepared, respectively, which is located in the stirring vessel during the given time period and, if applicable, changes of preparation parameters, which are to be derived therefrom.

However, it is preferred, in particular that the appliance part, which acts, such as in particular the stirring mechanism, is driven by an electrical motor and that a characteristic motor number, such as the speed and/or the motor current of the electric motor can be evaluated for determining the state parameter.

It is also preferred, in particular, that different quantities and/or types of food to be prepared must be placed into the stirring vessel one after the other for preparing the dish by way of executing a recipe by means of individual recipe steps and that the quantity and/or the type of the food to be prepared can be changed in response to a subsequent recipe step as a function of a state parameter (if applicable: environmental parameter) determined in response to a previous recipe step. For example, an olfactory sensor, for instance, can also be used to make it possible to determine that mustard, for example, for instance in response to the preparation of a dish, such as mayonnaise, was added in a quantity, which was too large, whereupon a notification can be given, which informs the user to add the food to be prepared, for example vinegar and/or egg yolk, which is to be added in a next recipe step, in a different quantity determined therefrom as compared to the actual quantity predetermined according to the recipe. A change of a preparation parameter can also be made in a subsequent recipe step as a function of a state parameter (if applicable: environmental parameter), which was determined in response to a previous recipe step, reference being made to examples specified above, whether automatically by the kitchen appliance or as displayed possibility, which the user must accept, for example for the actual conversion.

In particular the above-described method steps or the above-described embodiments, respectively, of the kitchen appliance of also considering afore-determined changes of a preparation parameter in response to a subsequent recipe step, also has an independent meaning.

The recipe execution is preferably provided such that - for instance between two recipe steps - every food to be prepared must be put in by a user. The kitchen appliance can stop for this purpose, but can also provide for a time window, in which food to be prepared is to be put in during the operation of the stirring mechanism and/or during a continued heating. For this purpose, the kitchen appliance furthermore preferably encompasses a display means, such a display, which can display the input of food to be prepared, which is to be carried out by the user, with regard to a type and/or quantity of the food to be prepared.

Said steps can accordingly also be carried out according to the method.

The mentioned possible embodiments of the kitchen appliance and the possible method are also explained below by means of the enclosed drawing.

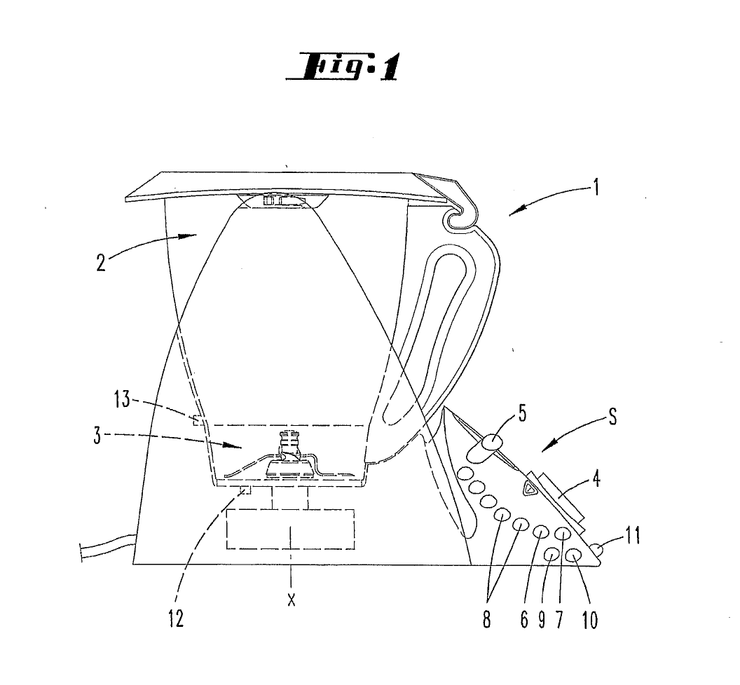

FIG. 1 shows a kitchen appliance, as it can be used herein;

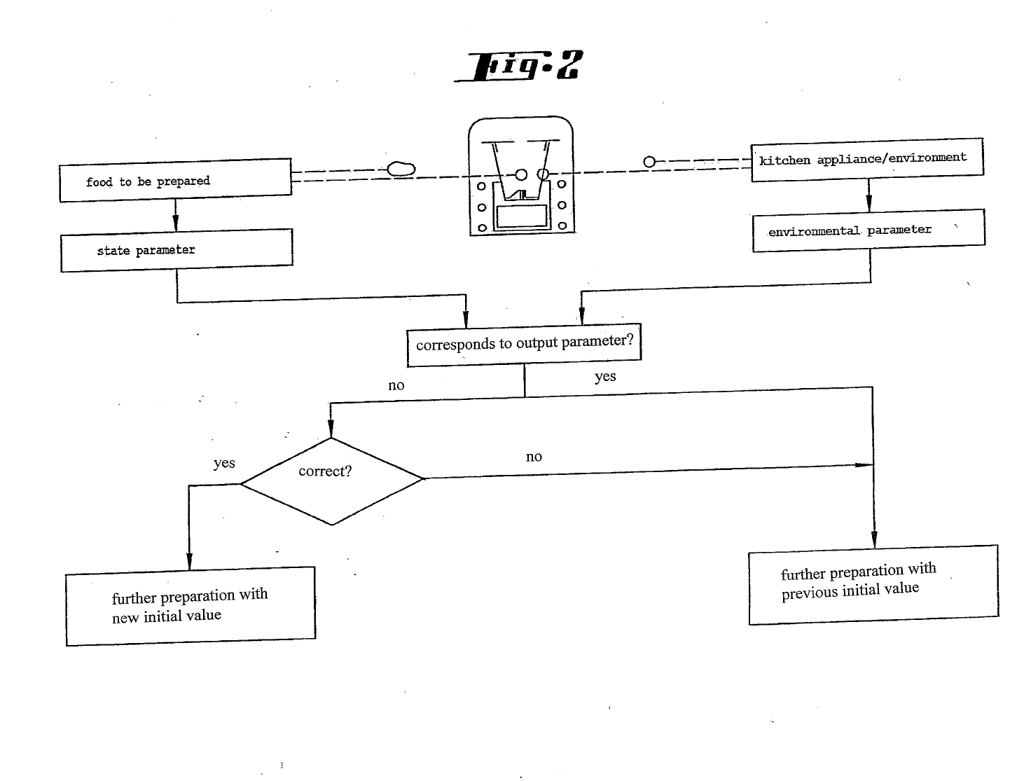

FIG. 2 shows a process flow diagram, as it can be carried out or as it can be carried out by means of the said kitchen appliance, respectively;

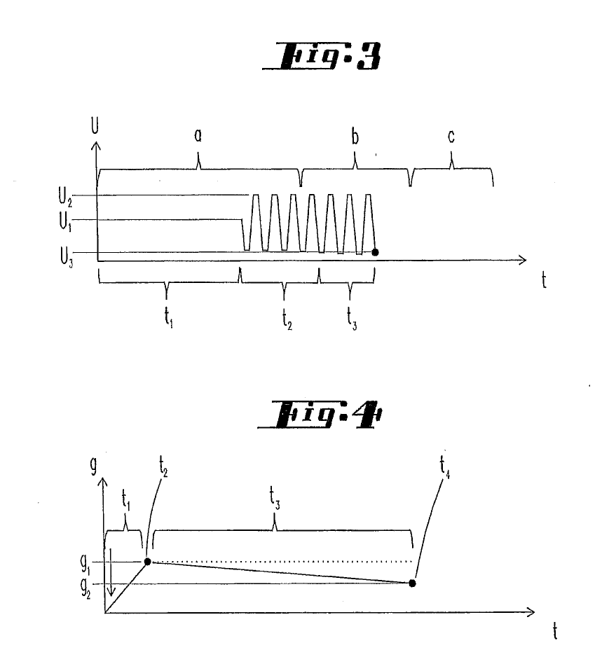

FIG. 3 shows a schematic illustration of a stirring mechanism activity using the example of a preparation of cream;

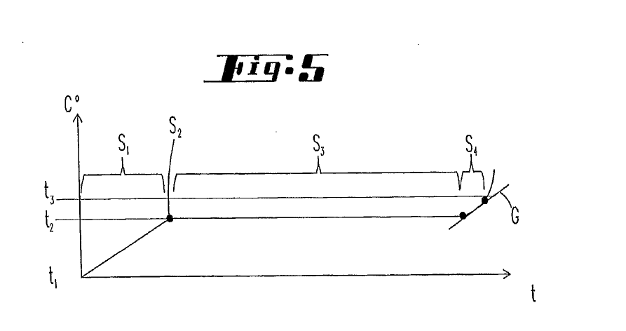

FIG. 4 shows a schematic illustration of a weight monitoring, using the example of a preparation of jam; and

FIG. 5 shows a schematic illustration of a temperature monitoring, using the example of a preparation of rice.

A kitchen appliance 1 is illustrated and described. The kitchen appliance 1 encompasses a stirring vessel 2, comprising a stirring mechanism 3 arranged at the bottom of the stirring vessel. The stirring vessel 2 can furthermore be heated, for example by means of an electric resistance heating (see, for instance, above-mentioned EP 1274333 B1), which is provided on the bottom side of the stirring vessel.

On the operating side S of the appliance, which can be seen in FIG. 1, provision is made for a display 4 and furthermore for a speed switch 5, for example, for adjusting a stirring mechanism speed. In addition, provision is made for actuating buttons 6 and 7 for adjusting a time via the display 4. Provision is furthermore made, for example, for buttons 8, which provide for a temperature preselection. In addition, provision is preferably made for switches 9 to 11 for triggering certain functions, such as, for instance, a turbo function, weighing function or the like. Instead of buttons and/or switches, provision can also be made for other influencing means, for example a touchscreen. In the latter case, corresponding symbols, which can then be changed by hand or by means of an aid by touching the screen, for instance with regard to a temperature sequence or a speed, etc., can appear, for example on the display, which is embodied as touchscreen.

As is not illustrated in detail, provision is furthermore made for a microprocessor and for at least one storage, which is preferably non-volatile, at least a data storage. Recipes, which are provided for automatic execution, and in particular individual recipe steps within a recipe can be stored for being processed by the microprocessor. However, settings can also be made independently in the machine via said actuating means or the automatic interventions can be made in the automatic execution in interaction with the recipe execution, respectively, for instance, as mentioned, for changing initial values (or initial value ranges) included in the automatic execution.

Provision can furthermore be made for sensors, such as one or a plurality of temperature sensors 12, 13. For example, they can be provided on the bottom of the stirring vessel and/or a wall of the stirring vessel, if applicable also assigned in different heights of the wall of the stirring vessel. Provision can furthermore also be made in or on the kitchen appliance for an air pressure and/or humidity sensor.

It is illustrated schematically in FIG. 2, in what manner the kitchen appliance proceeds or can be operated, respectively, according to the method. Initially, the mentioned measurement values are determined by the food to be prepared and/or by the kitchen appliance or the environment, respectively (with regard to a measurement value of the food to be prepared, which is determined outside of the stirring vessel, a potato is illustrated as symbol, for example), and is considered as state parameter (specially also: environmental parameter). They are compared with input initial values. If the determined measurement values correspond to the initial values, if applicable after a corresponding conversion, a preparation is carried out according to the provided sequence by means of the provided steps, such as, for instance, heating temperature of the stirring vessel and/or speed of the stirring mechanism. If the determined values do not correspond to the predetermined initial values, it is further examined, whether the initial values can be changed such that a further execution can be carried out in a sensible manner. In this case, new initial values are established and are preferably carried out automatically or it is left up to the user to carry out the further execution of a preparation step.

If the initial values cannot be changed such that the further execution is possible without very significantly influencing the quality of the food to be prepared, the preparation step is interrupted and it is accordingly displayed to the user or the user is given the option of continuing the preparation step nonetheless.

With reference to FIG. 3, the speed U of a stirring mechanism is illustrated schematically via the time axis t, in this example the preparation of cream. A constant speed U₁ is preferably applied to the initial medium via a first time period t₁. The speed U₁ can be in the range of between 200 and 300 U/min, for example. After the first time period t₁ has passed, a time period t₂ starts, in which a high speed U₂, which can be 400 U/min, for example, alternates with a low speed U₃. If applicable, the time period t₁ can also be forgone, the influence on the food to be prepared can thus also start at the same time as the alternating influence between a high speed and a low speed, if applicable. The low speed can be 40 U/min, for example. An automatic readjusting of the actual speed to the predetermined speed does not take place hereby in the range of the low speed. It will thus happen, if applicable after a repeated change between said speeds, here clarified in the time period t₃, that an undercutting of the actually lower speed U₃ occurs as compared to the predetermined speed U₃. In the case of the illustrated example, a first-time undercutting and, if applicable, also a further undercutting as individual fact has not yet been evaluated for providing an interruption of the stirring mechanism activity. According to the program, a certain plurality of undercuts can also first be evaluated with this in mind for this purpose, for instance so as to eliminate random values. In the alternative or additionally, provision can also be made for the stirring mechanism activity to be interrupted only in response to a significant undercutting, thus when the predetermined lower speed U₃ is undercut by a plurality of revolutions. In the case of the example, the lower speed U₃ is assumed to be 35 U/min and the interruption of the stirring vessel activity is provided, when an actual lower speed of 35 U/min is undercut.

Accordingly, different aggregate states, which appear after this, can also be differentiated via the time axis. In a first time period a, the food to be prepared is liquid. In a second time period b, it is cream-like and in a third time period c, which will not be reached here, it would be butter-like. Preferably, the high speed and the low speed are in each case maintained for a certain time period. This time period can in each case be within a range of a few seconds, 2 seconds, 3 seconds, 10 seconds, 20 seconds or more up to 1 minute or 2 minutes, for example, in each case.

With reference to FIG. 4, the monitoring and evaluation of the state parameter weight is clarified using the example of the preparation of jam. The weight g is shown via the time axis t.

Initially, within a time period t₁, the required ingredients are placed into the stirring vessel of the kitchen appliance. At a time period t₂, the preparation (cook jam) is then started by selecting a heating temperature and a stirring mechanism speed. The initial weight g₁ is determined at the same time.

At regular time intervals, which are not illustrated in detail, preferably without interrupting the preparation, a weight measurement is in each case carried out until the final weight g₂ has been reached, which, according to the program, then triggers the completion of the preparation, thus stops the heating and which, if applicable, then also has the result that the stoppage of the stirring mechanism is, turned off.

In the case of the example, the difference between g₁ and g₂ is based, for example, on 10 to 15 percent, more preferably on 12 percent of the initial weight g₁.

The inclusion of a temperature measurement, in particular the determination of a temperature gradient, in the execution program for ending the essential preparation effect, is described with reference to FIG. 5.

The temperature is shown here in degrees Celsius via the time axis t.

Initially, typically in response to an ambient temperature t₁, water and, if applicable salt and/or oil is placed into the stirring vessel and is heated for a time period S₁, namely to a boiling temperature t₂ of the water, which, as is well-known, is approx. 100° C. under usual conditions. The rice is added in the form of grains of rice at a point in time S₂, at which, on principle and preferably, the boiling temperature has already been reached as well. A further application of heat energy into the stirring vessel such that the boiling temperature t₂ is maintained, takes place for a time period S₃.

However, due to the fact that the boiling results in the evaporation of a certain portion of water at the same time, the water in the stirring vessel decreases continuously. In response to a continued supply of the heat energy, as it is typically required for maintaining the boiling temperature, the temperature increases within a time period S₄, because the limitation due to the boiling temperature of the water is no longer effective. Due to evaporating water, the applied heating power can no longer be discharged while maintaining the boiling temperature.

The temperature increase, which thus occurs in the time period S₄, can now be determined, for example by means of a continuous time measurement, which is carried out on the machine side within fixed predetermined time periods, and the ending of the execution program can be triggered in this respect when a certain temperature gradient G and/or a previously determined maximum temperature t₃ has been reached. The temperature t₃ can be 105° C., for example.

At the beginning of the execution program, the continuously performed temperature measurement can furthermore also be used to determine the point in time S₂ and to output a notification, for example, that the rice can now be added. If applicable, the temperature gradient can also be used in the alternative or additionally in this respect.

The temperature measurement in detail can take place in different ways. For example, the temperate of a hot plate, which can be located in the bottom of the stirring vessel, can be taken as measure for the significant temperature. A temperature sensor, which can also directly determine the temperature of the food to be prepared, at least in this wall area, can also be located in the wall of the stirring vessel.

With regard to the weight measurement, as it is the focus in the example according to FIG. 4, standard scale embodiments, such as a kitchen appliance, can be used. For example, provision can in each case be made in the feet of the kitchen appliance, by means of which it can stand on a countertop, for instance, for metering bars or weight sensors. The weight of the entire kitchen appliance, with the exception of the actual feet, can thus be determined. However, it can also only be a determination of the weight of the actual stirring vessel within the kitchen appliance.

All of the disclosed features (by themselves) are significant for the invention. The disclosure content of the corresponding/enclosed priority documents (copy of the earlier application) is hereby fully incorporated in the disclosure of the application, also for the purpose of adding features of these documents into the claims of the instant application. In their optional independent version, the subclaims characterize independent inventive further developments of the state of the art, in particular for filing divisional applications on the basis of these claims.

### REFERENCE LIST

1 kitchen appliance
2 stirring vessel
3 stirring mechanism
4 display
5 speed switch
6 actuating button
7 actuating button
8 button
9 switch
10 switch
11 switch
12 temperature sensor
13 temperature sensor
a 1^{st} time period
b 2^{nd} time period
c 3^{rd} time period
g weight
t time axis
s time period
G temperature gradient
S operating side
U speed

1-15. (canceled)

16. Kitchen appliance with an electrically driven motor comprising a heatable stirring vessel, which is formed to accommodate a stirring mechanism, wherein the kitchen appliance is made for automatically preparing a dish according to a predetermined execution program, wherein an environmental state with regard to state parameters, such as humidity or air pressure, can be measured or can be input as value, wherein a measurement value obtained hereby or input value can be compared to an initial value, which is considered in the execution program, and wherein deviations from the initial value can be considered by automatically adapting preparation parameters, such as heating time and/or heating temperature, which are included in the execution program.

17. The electrically driven kitchen appliance according to claim 16, wherein food to be prepared, which is placed into the stirring vessel, can be measured with regard to its state by means of sensors provided in or at the kitchen appliance or on the user side by means of a separate measuring instrument, determined with regard to a moisture as state parameter, or wherein a corresponding value can be input, wherein a measurement value obtained hereby or value can be compared to an initial value considered in an execution program and wherein deviations from the initial value can be considered by means of an automatic adaptation of preparation parameters included in the execution program, such as heating time and/or heating temperature.

18. The kitchen appliance according to claim 16, wherein the adaptation can be made in consideration of a threshold value, which is inherent to the food to be prepared, and/or wherein a state parameter can be determined by means of an appliance part, which has a preparatory effect on the food to be prepared in response to the preparation thereof, wherein, preferably, a sequence of movements, which also serves to determine the state parameter, can be carried out by means of the appliance part, wherein, more preferably, the appliance part, which acts, is driven by an electric motor and wherein a characteristic motor number, such as speed and/or the motor current of the electric motor can be evaluated for determining the state parameter, and/or the appliance part is the stirring mechanism and the sequence of movements is reached by means of an automatic sequence of different speeds of the stirring mechanism.

19. The kitchen appliance according to claim 16, wherein the quantity and/or the type of the food to be prepared can be changed in response to a subsequent recipe step as a function of a state and/or environmental parameter determined in response to a subsequent recipe step for preparing the dish by means of executing a recipe according to individual recipe steps, which are to be carried out one after the other, wherein different quantities and/or types of food to be prepared must be put into the stirring vessel one after the other.

20. The kitchen appliance according to claim 16, wherein the input of food to be prepared, which must be carried out by a user, can be displayed with regard to a type and/or a quantity of the food to be prepared.

21. The kitchen appliance according to claim 16, wherein an execution program includes an influence on a food to be prepared, which takes place by means of a predetermined first speed, wherein the kitchen appliance can maintain the first speed automatically by comparing it to the actual speed, and wherein the predetermined first speed can be changed, preferably decreased automatically to a predetermined second speed, wherein the kitchen appliance cannot maintain the second automatically, but wherein a monitoring of the actually reached speed is possible.

22. The kitchen appliance according to claim 16, wherein an execution program relates to a sequence of different speeds, maintained for a certain time period, wherein the kitchen appliance has a device for comparing the predetermined speed to an actual speed and, if applicable, for changing the actual speed to reach the predetermined speed, wherein a change of the actual speed with regard to the predetermined speed can also preferably not be carried out via the certain time period and wherein, if the speed was not changed, the actual speed, as compared to the predetermined speed, can be evaluated as measure for the viscosity of the food to be prepared.

23. The kitchen appliance according to claim 16, wherein the stirring mechanism can be turned off automatically in response to reaching a predetermined viscosity.

24. An electrically operated kitchen appliance comprising a heatable stirring vessel, which is embodied to accommodate a stirring mechanism, wherein the kitchen appliance is embodied for automatically preparing a dish according to a predetermined execution program, wherein a food to be prepared, which is placed into the stirring vessel, can be measured with regard to its weight, wherein a measurement value obtained hereby or a value can be compared to an initial value, which is considered in the execution program, wherein the weight can be checked continuously or within certain time intervals respectively, and wherein the execution program can be ended automatically as a function of reaching a predetermined weight.

25. The kitchen appliance according to claim 16, wherein a temperature measurement with regard to the food to be cooked, if applicable the temperature of a hot plate, can be carried out continuously or within certain time intervals in the course of an execution program, and wherein the execution program can be ended automatically when a predetermined temporal increase of the temperature is reached.

26. A method for automatically preparing a dish in an electrically driven kitchen appliance comprising a heatable stirring vessel, which is embodied to accommodate a stirring mechanism, wherein an environmental state is measured with regard to environmental parameters, such as an air pressure and/or humidity or wherein a corresponding value can be input, wherein a measurement value obtained hereby or input value is compared to an initial value, which is considered in an execution program, and wherein deviations from the initial value are used for adapting preparation parameters, such as heating time and/or heating temperature, which are included in the execution program.

27. The method according to claim 26, wherein food to be prepared, which is placed into the stirring vessel, is measured with regard to its state with regard to state parameters, such as a temperature and/or moisture of the food to be prepared, or wherein corresponding values can be input, wherein a measurement value obtained hereby or input value is compared to an initial value considered in an execution program and wherein deviations from the initial value are used for adopting preparation parameters, such as heating time and/or heating temperature, included in the execution program.

28. The method according to claim 26, wherein the adaptation is made in consideration of the threshold values, which are inherent to the food to be prepared, and/or wherein a preparation of the food to be prepared is determined by means of an appliance part, which has a preparatory effect on the food to be prepared, and/or a sequence of movements, which also serves to determine the state parameter, is carried out by means of the appliance part, wherein, preferably, the appliance part, which acts, is driven by an electric motor and wherein a characteristic motor number, such as speed and/or motor current of the electric motor is evaluated for determining the state parameter, wherein, more preferably, the appliance part is the stirring mechanism and the sequence of movements is reached by means of an automatic sequence of different speeds of the stirring mechanism.

29. The method according to claim 26, wherein the quantity and/or the type of the food to be prepared is changed in response to a subsequent recipe step as a function of a state and/or environmental parameter determined in response to a subsequent recipe step for preparing the dish by means of executing a recipe according to individual recipe steps, which are to be carried out one after the other, wherein different quantities and/or types of food to be prepared must be put into the stirring vessel one after the other.

30. The method according to claim 26, wherein the input of food to be prepared is carried out by a user, wherein, preferably, the kitchen appliance encompasses a display means, such as a display, and wherein the input of food to be prepared, which must be carried out by the user, is displayed with regard to a type and/or a quantity of the food to be prepared.
